(19) United States
(12) Patent Application Publication
(10) Pub. No.: US 2015/0019519 A1
(43) Pub. Date: Jan. 15, 2015

(54) LOCATION BASED SEARCH ENGINE POSITION

(71) Applicant: CONDUCTOR, INC., New York, NY (US)

(72) Inventors: VISHAL R. BERRY, NEW YORK, NY (US); DANWEN CHEN, NEW YORK, NY (US)

(21) Appl. No.: 13/941,157

(22) Filed: Jul. 12, 2013

(51) Int. Cl. G06F 17/30

(52) U.S. Cl. CPC G06F 17/30864
USPC 707/706

(57) ABSTRACT

System and methods for generating report data for a search engine are described. A processor may receive a URL, query, and first and second location data. The processor may apply localization techniques to the queries based on the first and second location data to produce first and second location metadata. The processor may send the query to a search engine with the first and second location metadata and receive first and second result sets in response. The processor may generate report data for the URL based on the result sets.

### BACKGROUND OF THE INVENTION

In a prior art search engine, a crawler aggregates pages from the Internet and ensures that these pages are searchable. The pages retrieved by the crawler are indexed by an indexer. For example, each web page may be broken down into words and respective locations of each word on the page. The pages are then indexed by the words and their respective locations. A user may send a search query to a dispatcher. The dispatcher may forward the query to search nodes. The search nodes search respective parts of the index and return search result along with a document characterization. The dispatcher merges the received result to produce a final result set displayed to a user sorted by ranking scores based on a ranking function. Users may modify web pages in an attempt to have their page appear higher in a result set for particular queries. This disclosure describes an improvement over these prior art technologies.

### SUMMARY OF THE INVENTION

One embodiment of the invention is a method for generating report data for a search engine, the method comprising, by a processor receiving a query, a uniform resource locator, a first location characterization and a second location characterization. The first location characterization and second location characterization may correspond to first and second locations, respectively. The method further comprising applying a localization technique on the query based of the first location characterization to produce first location metadata. The method further comprising sending the query and the first location metadata to a search engine. The method further comprising receiving a first result set from the search engine for the query based on the first location metadata, wherein the first result set includes the uniform resource locator. The method further comprising applying the localization technique on the query based of the second location characterization to produce second location metadata. The method further comprising sending the query and the second location metadata to the search engine. The method further comprising receiving a second result set from the search engine for the query based on the second location metadata, wherein the second result set includes the uniform resource locator. The method further comprising generating report data based on the query, the first and second location characterization, and the first and second result set.

One embodiment of the invention is a device effective to generate report data for a search engine, the device comprising a memory and a processor configured in communication with the memory. The processor effective to receive a query, a uniform resource locator, a first location characterization and a second location characterization. The first location characterization and second location characterization may correspond to first and second locations, respectively. The processor effective to apply a localization technique on the query based of the first location characterization to produce first location metadata. The processor effective to send the query and the first location metadata to a search engine. The processor effective to receive a first result set from the search engine for the query based on the first location metadata, wherein the first result set includes the uniform resource locator. The processor effective to apply the localization technique on the query based of the second location characterization to produce second location metadata. The processor effective to send the query and the second location metadata to the search engine. The processor effective to receive a second result set from the search engine for the query based on the second location metadata, wherein the second result set includes the uniform resource locator, The processor effective to generate report data based on the query, the first and second location characterization, and the first and second result set.

One embodiment of the invention is a system effective to generate a report, the system comprising a first and a second device. The first device comprising a display first processor configured in communication with the display. The first processor being effective to send a query, a uniform resource locator, a first location characterization and a second location characterization to the second device. The first location characterization and second location characterization may correspond to first and second locations, respectively. The second device comprising a memory and a second processor configured in communication with the memory. The second processor being effective to receive the query, the uniform resource locator, the first location characterization and the second location characterization. The second processor being effective to apply a localization technique on the query based of the first location characterization to produce first location metadata. The second processor being effective to send the query and the first location metadata to a search engine. The second processor being effective to receive a first result set from the search engine for the query based on the first location metadata, wherein the first result set includes the uniform resource locator. The second processor being effective to apply the localization technique on the query based of the second location characterization to produce second location metadata. The second processor being effective to send the query and the second location metadata to the search engine. The second processor being effective to receive a second result set from the search engine for the query based on the second location metadata, wherein the second result set includes the uniform resource locator. The second processor being effective to generate report data based on the query, the first and second location characterization, and the first and second result set. The second processor being effective to send the report data to the first device. The first processor being further effective to receive the report data from the second device and output the report on the display based on the report data.

### BRIEF DESCRIPTION OF THE FIGURES

The foregoing and other features of this disclosure will become more fully apparent from the following description and appended claims taken in conjunction with the accompanying drawings. Understanding that these drawings depict only some embodiments in accordance with the disclosure and are therefore not to be considered limiting of its scope, the disclosure will be described with additional specificity and detail by reference to the accompanying drawings in which:

FIG. 1 is a system drawing of a system that may implement a location based search engine position in accordance with an embodiment of the invention.

FIG. 2 illustrates a report which may be generated in accordance with an embodiment of the invention.

FIG. 3 is a flow chart illustrating a process which could be performed in accordance with an embodiment of the invention.

### DETAILED DESCRIPTION OF THE PREFERRED EMBODIMENT(S)

In the following detailed description, reference is made to the accompanying drawings which form a part thereof. In the drawings, similar symbols typically identify similar components unless context indicates otherwise. The illustrative embodiments described in the detailed description, drawings and claims are not meant to be limiting. Other embodiments may be utilized and other changes may be made without departing from the spirit or scope of the subject matter presented herein. It will be readily understood that the aspects of the present disclosure as generally described herein and as illustrated in the accompanying figures can be arranged, substituted, combined, separated and/or designed in a wide variety of different configurations all of which are explicitly contemplated herein.

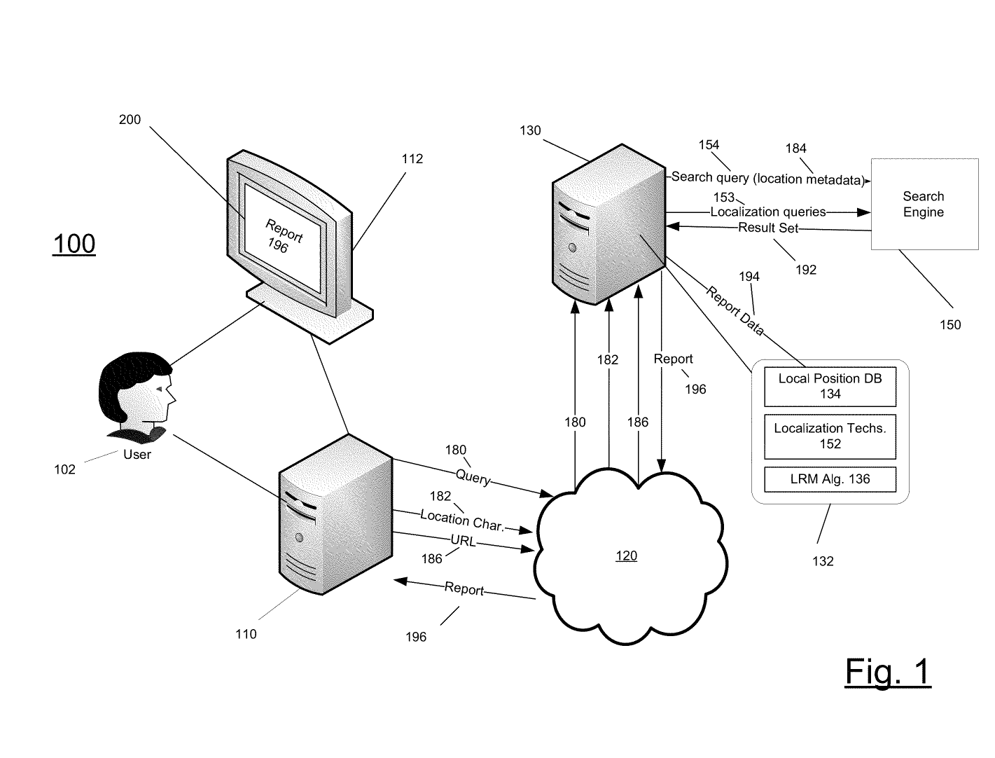

Referring to FIG. 1, there is shown an example system that may implement a location based search engine position arranged in accordance with at least some embodiments described herein. System 100 may include a display 112, a processor 110, and/or a processor 130, all configured in communication with each other through a network 120. Network 120 could include, for example, the Internet, a Local Area Network (LAN), a Wide Area Network (WAN), a BLUETOOTH network, or any other network type or protocol. Network 120 may include wireless, wired, and/or both wired and wireless communication links.

Processor 130 may be in communication with a memory 132. Memory 132 may include a local position mapping algorithm (LRM Alg.) 136, localization techniques 152, and/or a local position database 134. Display 112 may be configured to output a user interface 200 which may include a report 196 as discussed in more detail below.

A user 102 may control processor 110 to send one or more queries 180, two or more location characterizations 182, and a uniform resource locator (URL) 186 through network 120 to processor 130. Each query 180 could be, for example, one or more characters, symbols, operators, and/or words. Query 180 may include an image such as a picture with explicit location metadata (i.e. geographic data in an EXIF format) or implicit location metadata (i.e. where geographic data is inferred from analysis of the contents of the image). Query 180 could originate as speech. Location characterization 182 could correspond to a location and could be, for example, a name of a city, county, state, and/or region. URL 186 may be a URL for which user 102 desires to see a search engine position based on a location.

Processor 130 may receive queries 180, URL 186, and location characterizations 182. Processor 130 may apply one or more localization techniques 152 to query 180 based on location characterization 182 to produce location metadata 184. Location metadata 184 may be included in a search query 154 sent to search engine 150. Search engine 150 may be for example, GOOGLE, BING, YELP, etc. Search engine 150 may return a result set 192 based on location metadata 184.

Processor 130 may generate search query 154 including queries 180 and location metadata 184. Processor 130 may send search query 154 to search engine 150. In response to sending search query 154, processor 130 may receive result set 192 from search engine 150. Result set 192 may include one or more URLs arranged in a specific order of positions for queries 180 and based on location metadata 184.

Processor 130 may use local position mapping algorithm 136 to process result set 192 to generate report data 194. Processor 130 may store report data 194 in local position database 134. Report data 194 may include a position of URL 186 at a location corresponding to location characterization 182. URL 186 may be one of the URLs in result set 192. Processor 130 may generate a report 196 based on report data 192. Processor 130 may send report 196 to processor 110 to be outputted on display 112. User 102 may view, save, and/or modify report 196.

In an example localization technique 152, processor 130 may generate location metadata 184 by sending localization queries 153 to search engine 150. Localization queries 153 may be search queries for local businesses, landmarks, and/or any other information that relate to location characterization 182. Such relations may be explicit, such as when the query includes a name of a location, or implicit, such as when the query includes a name of an entity that, in turn, implies a location identified after semantic analysis. For example, if location characterization 182 is “New York City”, localization queries 153 may relate to “The Bronx Zoo” or “Chelsea”, etc. After receiving a number of localization queries 153, search engine 150 may generate result sets 192 for search queries 154 based on location characterization 182.

In another localization technique 152, processor 130 may generate client-specific location metadata 184 by assigning and/or modifying client specific location information relating to search engine 150. The client specific location information may include location characterization 182, and may cause search engine 150 to generate result sets 192 for search queries 154 based on location characterization 182.

In another localization technique 152, processor 130 may generate location metadata 184 by logging in to an account associated with search engine 150. The account may include location characterization 182. Processor 130 may log in to the account to generate location characterization 182. After logging in to the account, search engine 150 may generate result sets 192 for search queries 154 based on location characterization 182.

In another example localization technique 152, processor 130 may send search query 154 from an interface that defines location metadata 184. For example, processor 130 may instantiate a map and send search query 154 while a location corresponding to location characterization 182 is in a center of the map, the boundaries of the map, or a collection of notable entities visible within the instantiation of the map. Similarly, processor 130 may have an IP (internet protocol) address, such as a static IP address or dynamic IP address, that can be associated to location metadata 154. A dynamic IP address may be used in, for example, a mobile phone and the location of the mobile phone may define location metadata 184.

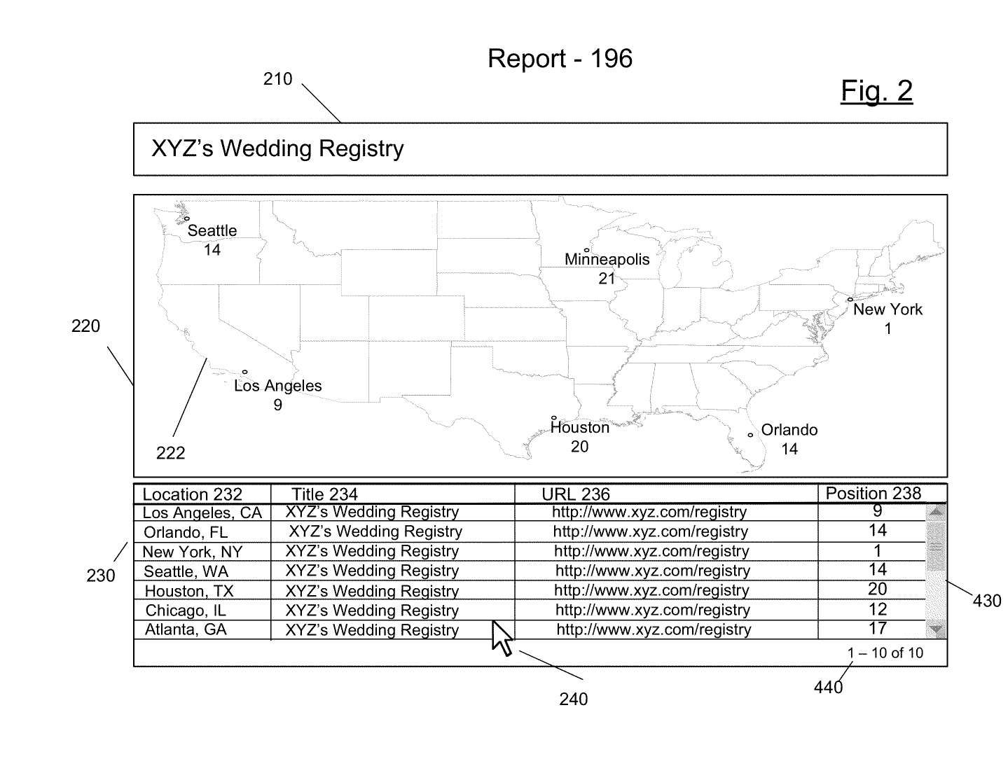

Referring to FIG. 2, there is shown a report 196 which may be generated in accordance with at least some embodiments described herein. User interface 200 may include a title field 210, a map module 220, and/or a location table module 230. A pointer 240 may be used by user 102 for navigation within the boundaries of user interface 200. Title field 210 may be configured to display a name or title of URL 186. Navigation of pointer 220 may be controlled by an input device, such as computer mouse, a keyboard, a touch screen, or any other human interface.

Map module 220 may include a map 222. Map 222 may be zoomed in or out within the boundaries of map module 220 using the input device that controls pointer 240. Map 222 may be a map of a country, such as the United States; a region, such as the Northeastern United States; a continent, such as North America; the entire globe and/or any other subdivision thereof. Map 222 may be configured to display names of cities, and/or states. Map 222 may be configured to display report data 194 reflecting positions of URL 186 by search engine 150 for queries 180 based on one or more locations. Positions of URL 186 may be displayed in association with location characterizations on map 222.

In the example shown, (looking at both FIGS. 1 and 2) user 102 may use processor 110 to send one or more queries 180 and the location characterization “New York” through network 120 to processor 130. Processor 130 may receive queries 180 and the location characterization “New York.” Processor 130 may apply a localization technique 152 to the queries based on location characterization “New York”, such as by logging in to an account associated with search engine 150, to produce location metadata 184 for the location characterization “New York.”

Processor 130 may send search query 154 including queries 180 and location metadata 184 to search engine 150, and receive result set 192. Result set 192 may reflect positions of URL 186 by search engine 150 for queries 180 based on location metadata 184 for location characterization “New York.” Processor 130 may use local position mapping algorithm 136 to process result set 192 to generate report data 194. Processor 130 may store report data 194 in local position database 134.

Processor 130 may generate report 196 based on report data 192. Processor 130 may send report 196 to processor 110 to be outputted on display 112 using user interface 200. User interface 200 may output report 196 by displaying the position of URL 186 by search engine 150 for queries 180 based on the location characterization “New York” adjacent to the location characterization “New York” on map 222.

User 102 may continue to send queries 180 and a new location characterization, such as “Orlando,” to processor 130 through network 120. Processor 130 may receive queries 180 and the location characterization “Orlando.” Processor 130 may apply a localization technique 152 to the queries based on location characterization “Orlando” to produce location metadata 184 for location characterization “Orlando,” such as by sending five localization queries 153 for restaurants in Orlando to search engine 150.

Processor 130 may send search query 154 including queries 180 and location metadata 184 to search engine 150, and receive result set 192. Result set 192 may reflect positions of URL 186 for queries 180 based on the location metadata 184 for the location characterization “Orlando.” Processor 130 may use local position mapping algorithm 136 to process result set 192 to generate report data 194. Processor 130 may store report data 194 in local position database 134. Report data 194 may include positions of URL 186 in result set 192.

Processor 130 may generate report 196 based on report data 194. Processor 130 may send report 196 to processor 110 to be outputted on display 112 using user interface 200. User interface 200 may output report 196 by displaying the positions of URL 186 for queries 180 based on the location characterization “Orlando” adjacent to the location characterization “Orlando” on map 222.

Local table module 230 may include location field 232, a title field 234, a URL field 236 and/or position field 238. Location field 232 may include data relating to locations identified by location characterization 182. Title field 234 may include data relating to a title of URLs in URL field 236. URL field 236 may include URLS from URL 186. Position field 238 may include data relating to a position of URL 236 by search engine 150 for queries 180 based on location 232.

In an example, user 102 may be interested in the position of the XYZ website for query “wedding registry” based on the location characterization “New York”. User 102 may use processor 110 to send the queries “wedding registry,” the URL for the XYZ's website, and the location characterization “New York” through network 120 to processor 130. Processor 130 may receive queries “wedding registry,” URL 186 and location characterization 182. Processor 130 may apply a localization technique 152 to queries based on location characterization “New York,” such as by logging in to an account associated with search engine 150, to generate location metadata 184 for the location characterization “New York.”

Processor 130 may send search query 154 including the queries “wedding registry” and location metadata 184 to search engine 150, and receive result set 192 reflecting positions of URL 186 by search engine 150 for queries “wedding registry” based on the location characterization “New York.” Processor 130 may use local position mapping algorithm 136 to process result set 192 to generate report data 194. Processor 130 may store report data 194 in local position database 134. Processor 130 may generate report 196 based on report data 192. Processor 130 may send report 196 to processor 110 to be outputted on display 112 using user interface 200.

Among other potential benefits, a system in accordance with the disclosure may provide a marketing professional with guidance as to how to improve positions of a URL at different locations. A user may see positions of the URL's for queries based on one or more different locations. For example, the position of the URL may be higher than anticipated at a few locations, yet lower than anticipated in other locations. The user may use this data to identify ways to improve URL position. A user can identify a position of a URL he owns and the position of a URL of a competitor for the same query at two or more locations and make marketing decisions in response.

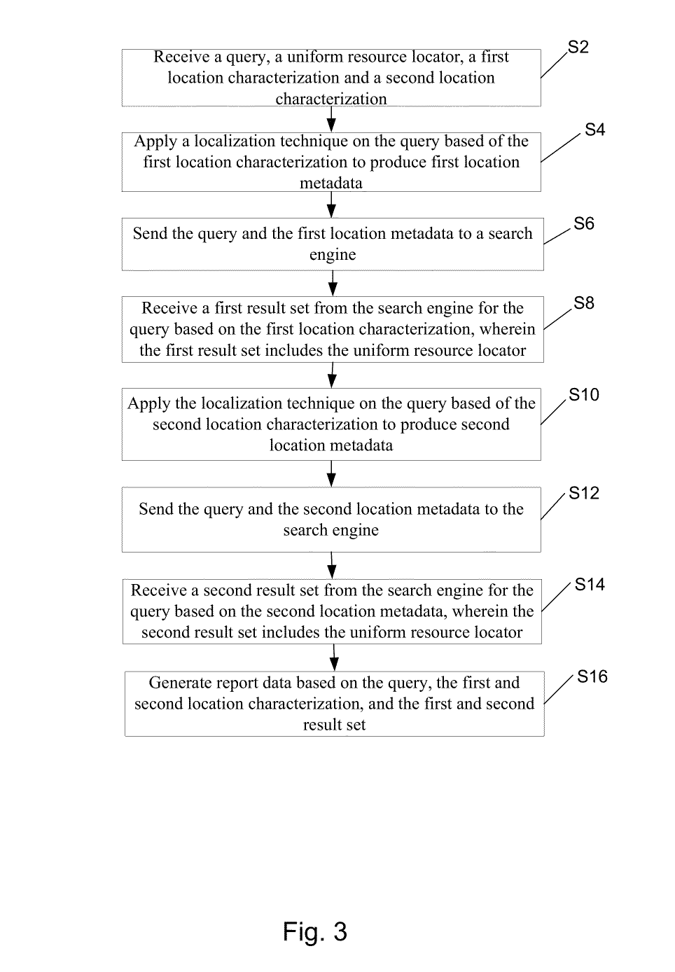

Referring to FIG. 3, there is shown a process which could be performed in accordance with an embodiment of the invention. The process could be performed using, for example, system 100 discussed above. As shown, at block S2, a processor may receive a query, a uniform resource locator, a first location characterization and a second location characterization. At block S4, the processor may apply a localization technique on the query based on the first location characterization to produce first location metadata. At block S6, the processor may send the query and the first location metadata to a search engine. At block S8, the processor may receive a first result set from the search engine for the query based the first location metadata. The first result set may include the uniform resource locator.

At block S10, the processor may apply the localization technique on the query based on the second location characterization to produce second location metadata. At block S12, the processor may send the query and the second location metadata to the search engine. At block S14, the processor may receive a second result set from the search engine for the query based on the second location metadata. The second result set may include the uniform resource locator.

At block S16, the processor may generate report data based on the query, the first and second location characterization, and the first and second result set. The report data may include a position of the uniform resource locator. The processor may generate a report based on the report data. The report may display the position of the uniform resource locator for the first and second location characterization. The processor may generate a map. The map may include the first position in association with the first location characterization and the second position in association with the second location characterization. The processor may generate a table. The table may include the first position in association with the first location characterization and the second position in association with the second location characterization.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A method for generating report data for a search engine, the method comprising, by a processor:
receiving a query, a uniform resource locator, a first location characterization and a second location characterization, where the first location characterization and the second location characterization correspond to a first and second location, respectively;
applying a localization technique on the query based of the first location characterization to produce first location metadata;
sending the query and the first location metadata to a search engine;
receiving a first result set from the search engine for the query based on the first location metadata, wherein the first result set includes the uniform resource locator;
applying the localization technique on the query based of the second location characterization to produce second location metadata;
sending the query and the second location metadata to the search engine;
receiving a second result set from the search engine for the query based on the second location metadata, wherein the second result set includes the uniform resource locator; and
generating report data based on the query, the first and second location characterization, and the first and second result set.

2. The method of claim 1, wherein the report data includes a first position of the uniform resource locator at the first location and a second position of the uniform resource locator at the second location.

3. The method of claim 1, further comprising generating a report based on the report data, wherein the report displays a first position of the uniform resource locator associated with the first location characterization and a second position of the uniform resource locator associated with the second location characterization.

4. The method of claim 3, wherein the first position is different from the second position.

5. The method of claim 3, further comprising generating a map, wherein the map includes the first position in association with the first location characterization and the second position in association with the second location characterization.

6. The method of claim 5, further comprising generating a table, wherein the table includes the first position in association with the first location characterization and the second position in association with the second location characterization.

7. The method of claim 1, wherein the localization technique includes using an account associated with the search engine.

8. The method of claim 1, wherein the localization technique includes sending one or more queries to the search engine, where the queries relate to the first or second location.

9. The method of claim 1, wherein the localization technique includes modifying a users client specific location information that relates to the search engine.

10. A device effective to generate report data for a search engine, the device comprising:
a memory;
a processor configured in communication with the memory, the processor effective to:
receive a query, a uniform resource locator, a first location characterization and a second location characterization, where the first location characterization and the second location characterization correspond to a first and second location, respectively;
apply a localization technique on the query based of the first location characterization to produce first location metadata;
send the query and the first location metadata to a search engine;
receive a first result set from the search engine for the query based on the first location metadata, wherein the first result set includes the uniform resource locator;
apply the localization technique on the query based of the second location characterization to produce second location metadata;
send the query and the second location metadata to the search engine;
receive a second result set from the search engine for the query based on the second location metadata, wherein the second result set includes the uniform resource locator; and
generate report data based on the query, the first and second location characterization, and the first and second result set.

11. The device of claim 10, wherein the processor is further effective to generate a report based on the report data, wherein the report displays a first position of the uniform resource locator associated with the first location characterization and a second position of the uniform resource locator associated with the second location.

12. The device of claim 10, wherein the first position is different from the second position.

13. The device of claim 12, wherein the processor is further effective to generate a map, wherein the map includes the first position in association with the first location characterization and the second position in association with the second location characterization.

14. The device of claim 13, wherein the processor is further effective to generate a table, wherein the table includes the first position in association with the first location characterization and the second position in association with the second location characterization.

15. The device of claim 10, wherein the localization technique includes a log into an account associated with the search engine.

16. The device of claim 10, wherein the localization technique includes one or more queries sent to the search engine, where the queries relate to the first or second location.

17. The device of claim 10, wherein the localization technique includes modification of a users client-specific location information that relates to the search engine.

18. A system effective to generate a report, the system comprising:
a first device, the first device comprising:
a display; and
a first processor configured in communication with the display, the first processor being effective to send a query, a uniform resource locator, a first location characterization and a second location characterization to a second device, where the first location characterization and the second location characterization correspond to a first and second location, respectively;
the second device comprising:
a memory;
a second processor configured in communication with the memory, the second processor being effective to:
receive the query, the uniform resource locator, the first location characterization and the second location characterization;
apply a localization technique on the query based of the first location characterization to produce first location metadata;
send the query and the first location metadata to a search engine;
receive a first result set from the search engine for the query based on the first location metadata, wherein the first result set includes the uniform resource locator;
apply the localization technique on the query based of the second location characterization to produce second location metadata;
send the query and the second location metadata to the search engine;
receive a second result set from the search engine for the query based on the second location metadata, wherein the second result set includes the uniform resource locator;
generate report data based on the query, the first and second location characterization, and the first and second result set; and
send the report data to the first device;
the first processor being further effective to:
receive the report data from the second device; and
output a report on the display based on the report data.

19. The device of claim 18, wherein the processor is further effective to:
generate a map, wherein the map includes the first position in association with the first location characterization and the second position in association with the second location characterization; and
a table, wherein the table includes the first position in association with the first location characterization and the second position in association with the second location characterization.

20. The system of claim 18, wherein the localization technique includes one of:
a log into an account associated with the search engine;
one or more queries to the search engine, where the queries relate to the first or second location; or
modification of a users client-specific location information that relates to the search engine.
